(19) United States
(12) Patent Application Publication
(10) Pub. No.: US 2005/0030282 A1
(43) Pub. Date: Feb. 10, 2005

(54) Device and method for displaying a screen in a wireless terminal

(76) Inventors: Byeong-Kuk Lee, Gumi-si (KR); Jong-Chul Lee, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/911,542

(22) Filed: Aug. 5, 2004

(30) Foreign Application Priority Data
Aug. 8, 2003 (KR) 2003-54928

(51) Int. Cl. G09G 5/00

(52) U.S. Cl. 345/156

(57) ABSTRACT

A device and method for displaying a screen in a wireless terminal are provided. The device and method comprise a display section for displaying input data, the display section including a first display section and a second display section, a display drive section having an address region for the first display section and an address region for the second display section, and a control section for controlling the display drive section to display input data on the first display section and the second display section.

### PRIORITY

This application claims the benefit under 35 U.S.C. § 119(a) of an application entitled “Device and method for displaying screen in wireless terminal” filed in the Korean Intellectual Office on Aug. 8, 2003 and assigned Serial No. 2003-54928, the entire contents of which are incorporated herein by reference.

### BACKGROUND OF THE INVENTION

1. Field of the Invention

The present invention relates to a wireless terminal. More particularly, the present invention relates to a device and a method for controlling at least two display sections by using one display drive section.

2. Description of the Related Art

A wireless terminal requires one LCD drive section for controlling one display section. As shown in FIG. 1, therefore, in the case of a dual wireless terminal including two display sections 71 and 72, two LCD drive sections 60 and 61 must be included so as to control the two display sections 71 and 72, respectively. Also, if the display sections are supported by a touch pad 80, a touch pad screen drive section 85 must be included separately.

In the case of the above-mentioned dual wireless terminal having two display sections, it is difficult to mount and create such a mechanical structure and circuit because the display sections use their respective LCD drive sections, and there is a problem in that material costs increase due to the two LCD drive sections included in a wireless terminal.

### SUMMARY OF THE INVENTION

Accordingly, the present invention has been made to solve the above-mentioned problems occurring in the prior art, and an object of the present invention is to provide a device and a method for controlling at least two display sections by using one display drive section.

Another object of the present invention is to provide a device and a method for controlling at least two display sections and detecting inputs from a touch pad by using one display drive section.

To accomplish these objects, in accordance with one aspect of the present invention, there is provided a device for displaying a screen in a wireless terminal. The device comprises a display section for displaying input data, the display section including a first display section and a second display section; a display drive section having an address region for the first display section and an address region for the second display section; and a control section for controlling the display drive section to display input data on the first display section and the second display section.

In accordance with another aspect of the present invention, there is provided a device for displaying a screen in a wireless terminal. The device comprises a display section for displaying input data, the display section including a first display section and a second display section; a touch pad section for performing an input operation through a touch; a display drive section having an address region for the first display section and an address region for the second display section, and detecting the touch on the touch pad section; and a control section for controlling the display drive section to display input data on the first display section and the second display section.

Also, in accordance with still another aspect of the present invention, there is provided a method for displaying a screen in a wireless terminal. The method comprising inputting data; detecting an address of the input data; displaying the data on a first display section and/or a second display section according to the address of the data.

Also, in accordance with still another aspect of the present invention, there is provided a method for displaying a screen in a wireless terminal, the method comprising the steps of: judging whether a folder is opened or closed when data are input; detecting an address of the data when the folder is detected to be opened; and displaying the data on at least one of a first display section and a second display section according to the address of the data.

Also, in accordance with still another aspect of the present invention, there is provided a method for displaying a screen in a wireless terminal which includes a touch pad and a display section having a first and a second display section. The method comprising generating a first event through an input from the touch pad; generating a second event through another input from the touch pad during an execution of the first event; reading a coordinate value of the first event to display relevant data on the display section; and reading a coordinate value of the second event to display relevant data on the display section when the execution of the first event is completed.

Also, in accordance with still another aspect of the present invention, there is provided a method for displaying a screen in a wireless terminal which includes a touch pad and a display section having a first and a second display section. The method comprising generating a first event through an input from the touch pad; generating a second event through another input from the touch pad during an execution of the first event; and reading a coordinate value of the second event to display relevant data on the display section after ending the execution of the first event.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a device for displaying data in a conventional wireless terminal;

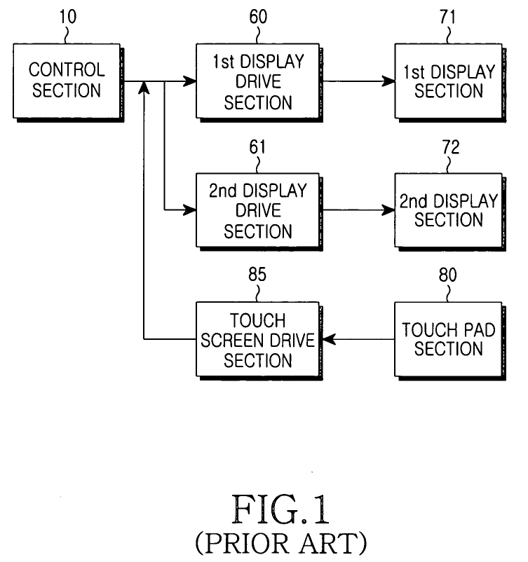

FIG. 2 is a block diagram illustrating a wireless terminal according to an embodiment of the present invention;

FIG. 3 is a block diagram illustrating a device for displaying a screen in a wireless terminal according to an embodiment of the present invention;

FIG. 4 is a block diagram illustrating a device for displaying a screen in a wireless terminal according to another embodiment of the present invention;

FIG. 5 is a flowchart illustrating a method of displaying images on a first and a second display section according to the open or closed state of a folder in a wireless terminal according to a first embodiment of the present invention;

FIG. 6 is a flowchart illustrating a method of displaying data corresponding to the input of a touch pad on a first and a second display section in a wireless terminal according to a second embodiment of the present invention; and

FIG. 7 is a flowchart illustrating a method of displaying data corresponding to the input of a touch pad on a first and a second display section in a wireless terminal according to a third embodiment of the present invention.

Throughout the drawings, it should be noted that the same or similar elements are denoted by like reference numerals.

### DETAILED DESCRIPTION OF THE PREFERRED EMBODIMENTS

A device and a method for displaying a screen in a wireless terminal according to embodiments of the present invention will now be described with reference to the accompanying drawings.

Although a number of exemplary features, such as displayed data and a used channel, and so on, are described and shown, the present invention can be practiced without the exemplary features. In the following description of embodiments of the present invention, a detailed description of known functions and configurations incorporated herein will be omitted for conciseness.

In embodiments of the present invention, a second display section refers to a sub-display section, which is mounted on the exterior face of a wireless terminal so as to enable a screen to be displayed when the folder of the wireless terminal is closed. Also, in embodiments of the present invention, a first display section refers to a main display section, which is mounted on the interior face of the wireless terminal so as to enable a screen to be displayed when the folder of the wireless terminal is opened. Herein, while the first display section displays a screen, the second display section mounted on the exterior face of the wireless terminal may also display a screen. In addition, in embodiments of the present invention, addresses of data refer to the screen sizes of the first and the second display section.

Regarding embodiments of the present invention, a wireless terminal having a camera is provided as an example. However, embodiments of the present invention may be practiced with a common wireless terminal having no camera or a wireless terminal having a TV receiver.

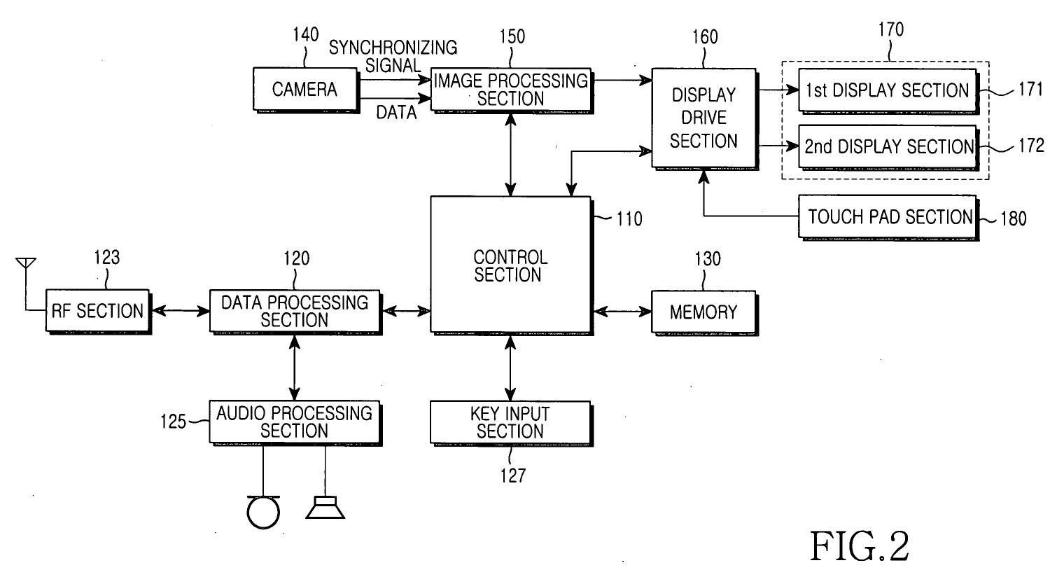

FIG. 2 is a block diagram illustrating a wireless terminal having a camera according to an embodiment of the present invention.

Referring to FIG. 2, a Radio Frequency (RF) section 123 performs a wireless communication function. The RF section 123 includes an RF transmission section (not shown) which up-converts a frequency of a signal to be transmitted and amplifies the signal to be transmitted, and an RF reception section (not shown) which amplifies a received signal with a low noise and down-converts a frequency of the received signal. A data processing section 120 includes a transmission section (not shown) for coding and modulating the signal to be transmitted and a reception section (not shown) for demodulating and decoding the received signal. That is, the data processing section 120 can be realized by a modulator/demodulator (MODEM) and a coder/decoder (CODEC). Herein, the CODEC includes a data CEDEC for processing packet data and the like and an audio CODEC for processing audio signals, such as voice. An audio processing section 125 functions to reproduce a received audio signal output from the audio CODEC of the data processing section 120 and to transmit a transmission audio signal, which has been generated from a microphone, into the audio CODEC of the data processing section 120.

A memory 130 may include a program memory (not shown) and a data memory (not shown). The program memory may store programs for controlling general operations of the wireless terminal and programs for controlling to display a screen on a display section corresponding to an address of data input according to an embodiment of the present invention. Also, the data memory functions to temporarily store data generated while the above-mentioned programs are performed. A camera module 140 includes a camera sensor for photographing an image and for converting an optical signal obtained through photographing into an electrical signal, and a signal processing section for converting an analog image data obtained by the camera sensor into digital data. Herein, it is assumed that the camera sensor is a charge-coupled device (CCD) sensor, and the signal processing section may be realized by a digital signal processor (DSP). The camera sensor and the signal processing section may be integrally or separately constructed.

An image processing section 150 functions to generate image data for displaying an image signal output from the camera module 140. The image processing section 150 processes an image signal, which is output from the camera module 140, in a unit of frame, and outputs the frame image data according to the size and the property of a display section 170. Also, the image processing section 150 includes an image CODEC so as to compress frame image data displayed on the display section 170 by using a predetermined method and to reproduce original frame image data from compressed frame image data. Herein, the image CODEC may be one of a Joint Photographic Experts Group (JPEG) CODEC, an Moving Picture Experts Group 4 (MPEG4) CODEC, and a Wavelet CODEC. The image processing section 150 is assumed to have an On Screen Display (OSD) function, and can output OSD data according to the size of a screen displayed under the control of a control section 110. A key input section 127 includes keys for inputting numerical and letter information and function keys for setting various functions.

A display drive section 160 may include an address region of a first display section 171 and an address region of a second display section 172 according to an embodiment of the present invention. Also, the display section 160 may include an address region of a first display section 171 and an address region of a second display section 172 and can detect the input of a touch pad according to a second embodiment of the present invention.

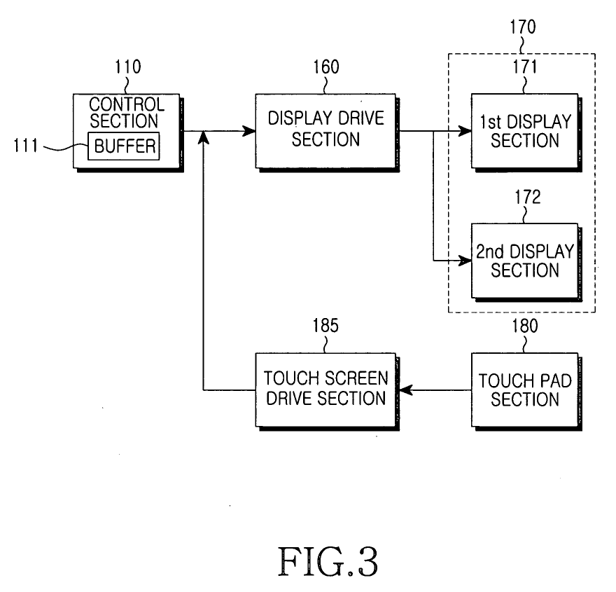

In the following description, a construction of a wireless terminal including the display drive section 160 according to the first embodiment of the present invention will be explained in detail with reference to FIG. 3.

Referring to FIG. 3, the display section 170 includes the first display section 171 mounted on the interior face of the wireless terminal and the second display section 172 mounted on the exterior face of the wireless terminal, displays an image signal output from the image processing section 150 on a screen, and displays user data output from the control section 110. The control section 110 functions to control the whole operation of the wireless terminal. Also, the control section 110 may include the data processing section 120. After detecting the address of data input according to the first embodiment of the present invention, the control section 110 controls the display drive section 160 to output the data to the first display section 171 and/or the second display section 172 corresponding to the address. In addition, the control section 110 receives an input coordinate value of a touch pad from a touch screen drive section 185 (see FIG. 3), and outputs data corresponding to the input coordinate value into the first display section 171 and/or the second display section 172 through the display drive section 160. Herein, the control section 110 may include a buffer 111 (see FIG. 3) which stores data to be output into the display section 170. The display drive section 160 includes an address region for the first display section and an address region for the second display section, and outputs data input under the control of the control section 110 into a corresponding display section through a corresponding address region. A touch pad section 180 performs an input operation through the touch of a pen or a user's finger. The touch screen drive section 185 detects the touch of a pen or a user's finger, and transfers a coordinate value input through the touch into the control section 110.

The operation of displaying a screen in a wireless terminal including the display drive section as shown in FIG. 3 will now be described. When either the image processing section 150 outputs an image signal or user data are input into the control section 110, the control section 110 detects this and detects the address of the image signal or the user data. At this time, if the input data—that is, either the image signal or the user data—have the first display-section address region, the control section 110 detects this and outputs the input data into the first display section 171 through the first display-section address region of the display drive section 160. Also, if the input data have the second display-section address region, the control section 110 detects this and outputs the input data into the second display section 172 through the second display-section address region of the display drive section 160. In addition, if the input data have both the first and the second display-section address region, the control section 110 detects this and may simultaneously output the input data into the first and the second display section 171 and 172 through the first and the second display-section address region of the display drive section 160.

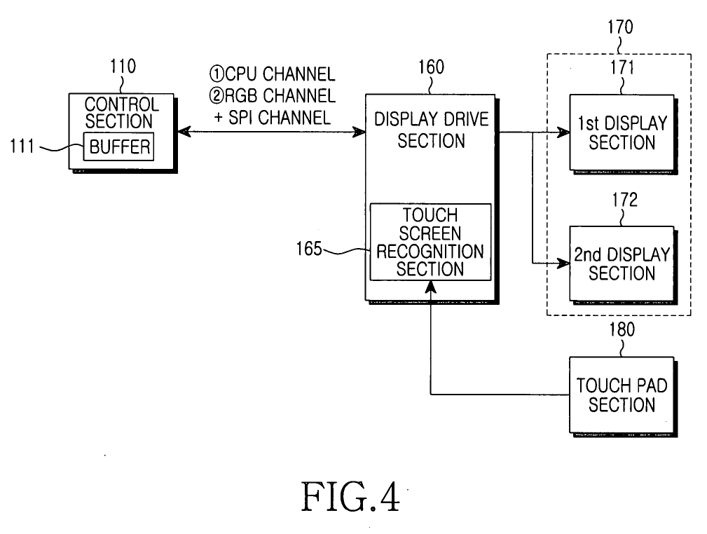

In the following description, a construction of a wireless terminal including the display drive section 160 according to the second embodiment of the present invention will be explained in detail with reference to FIG. 4. Referring to FIG. 4, the display section 170 includes the first display section 171 mounted on the interior face of the wireless terminal and the second display section 172 mounted on the exterior face of the wireless terminal, displays an image signal output from the image processing section 150 on a screen, and displays user data output from the control section 110.

The control section 110 functions to control the whole operation of the wireless terminal. Also, the control section 110 may include the data processing section 120. After detecting the address of data input according to an embodiment of the present invention, the control section 110 controls the display drive section 160 to output the data to the first display section 171 and/or the second display section 172 corresponding to the address. In addition, the control section 110 receives an input coordinate value of a touch pad 180 through the display drive section 160, and outputs data corresponding to the input coordinate value into the first display section 171 and/or the second display section 172 through the display drive section 160. Herein, the control section 110 may include a buffer 111 which stores data to be output into the display section 170.

The display drive section 160 includes an address region for the first display section and an address region for the second display section, and outputs data input under the control of the control section 110 into a corresponding display section through a corresponding address region. Also, the display drive section 160 includes a touch screen recognition section 165. When a finger or a pen touches the touch pad section 180, the display drive section 160 detects this through the touch screen recognition section 165 and transfers a coordinate value input through the touch into the control section 110.

The operation of displaying a screen in a wireless terminal including the display drive section as shown in FIG. 4 will now be described. When either the image processing section 150 outputs an image signal or user data are input into the control section 110, the control section 110 detects this and detects the address of the image signal or the user data. At this time, if the input data, that is, either the image signal or the user data, have the first display-section address region, the control section 110 detects this and outputs the input data into the first display section 171 through the first display-section address region of the display drive section 160. Also, if the input data have the second display-section address region, the control section 110 detects this and outputs the input data into the second display section 172 through the second display-section address region of the display drive section 160. In addition, if the input data have both of the first and the second display-section address region, the control section 110 detects this and may simultaneously output the input data into the first and the second display section 171 and 172 through the first and the second display-section address region of the display drive section 160. Also, when a user performs an input operation though the touch pad section 180 by means of a finger or a pen, the touch screen recognition section 165 of the display drive section detects this and reads coordinates input on the touch pad section 180 to transfer the coordinates to the control section 110. Then, the control section 110 outputs data corresponding to the coordinates. At this time, the control section 110 detects the address of the data, and then outputs the data to the first display section 171 or the second display section 172 through the first display-section address region or the second display-section address region of the display drive section 160. Also, the control section 110 may simultaneously output the data to both of the first display section 171 and the second display section 172 through the first display-section address region and the second display-section address region of the display drive section 160.

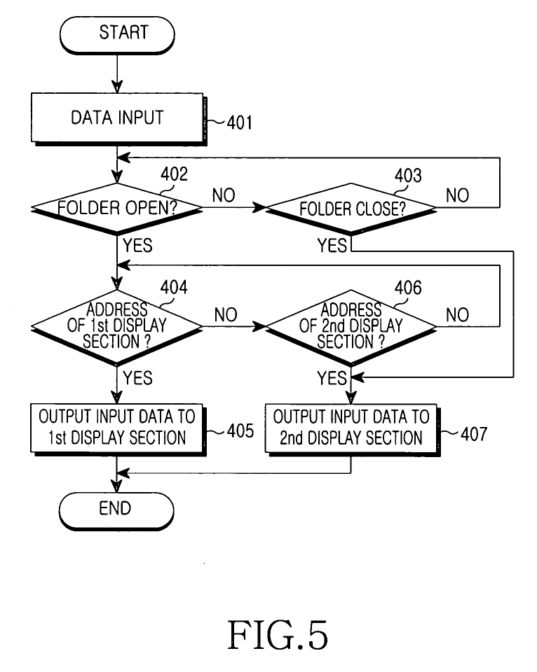

FIGS. 5, 6 and 7 represent examples of methods for displaying screens in wireless terminals including the display drive section shown in FIG. 4. Hereinafter, the operations of displaying screens in wireless terminals will be explained in detail with reference to FIGS. 5, 6 and 7.

FIG. 5 is a flowchart for explaining a method of displaying images on the first and the second display section according to the open or closed state of a folder in a wireless terminal according to a first embodiment of the present invention. In the first embodiment of the present invention, ‘data’ refers to an image signal output from the image processing section and/or user data output from the control section. Also, the first embodiment of the present invention will be described based on the assumption that the first display section has a screen size of ‘96×64’, the second display section has a screen size of ‘128×160’, and the whole address region of the display drive section is ‘224×224’. Herein, it is also assumed that the first display-section address region of the display drive section is ‘96×64’ and the second display-section address region of the display drive section is ‘128×160’. In addition, in the first embodiment of the present invention, the control section may include a buffer which stores data to be output to the display section so that the control section may output the data stored in the buffer when outputting the data to the display section.

Hereinafter, the first embodiment of the present invention will be described in detail with reference to FIGS. 2 and 4.

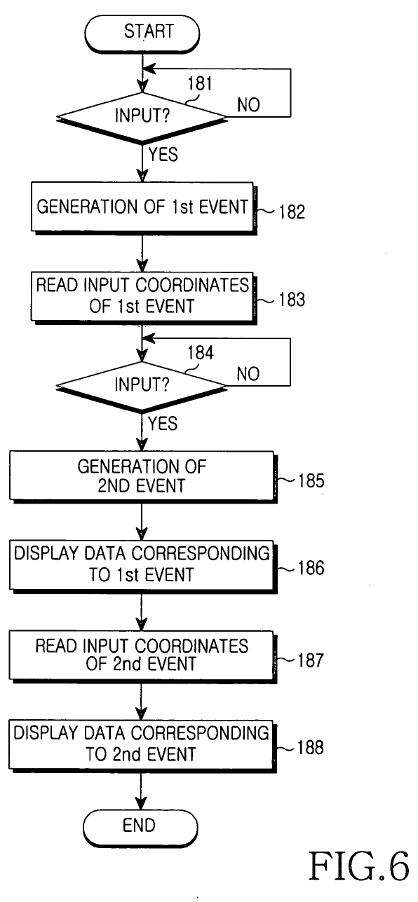

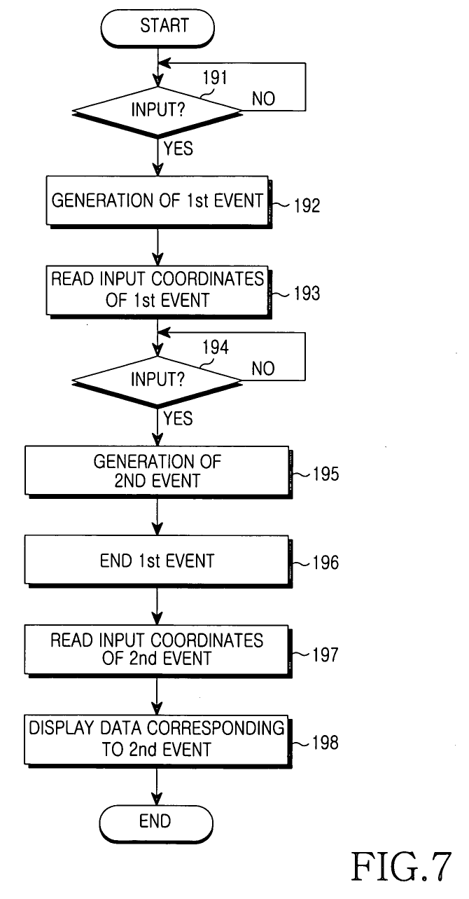

Referring to FIG. 5, when data is input at step 401, the control section 110 detects this and determines whether the folder of the wireless terminal is opened or closed. At this time, if the folder of the wireless terminal is opened, the control section 110 detects this at step 402 and detects the address of the input data. Then, if the address of the input data is ‘96×64’ corresponding to the first display-section address, the control section 110 detects this at step 404 and performs step 405 to output the data onto the first display section 171 through the first display-section address region of the display drive section 160. In contrast, if the address of the input data is ‘128×160’ corresponding to the second display-section address, the control section 110 detects this at step 406 and performs step 407 to output the data into the second display section 172 through the second display-section address region of the display drive section 160. In addition, if the address of the input data has both the first display-section address and the second display-section address, the control section 110 will detect this and simultaneously output the data into both the first and the second display section 171 and 172 through the first and the second display-section address region of the display drive section. Meanwhile, when the control section 110 determines whether the folder of the wireless terminal is opened or closed, if the folder of the wireless terminal is closed, the control section 110 detects this at step 403 and performs step 407 to output the data into the second display section 172 through the second display-section address region of the display drive section 160. Also, when a pen touches the touch pad 180, the touch screen recognition section 165 of the display drive section 160 detects this and transfers coordinates input through the touch to the control section 110. Then, the control section 110 performs a control operation to output data corresponding to the transferred coordinates into the display section through the display drive section. The methods of displaying data through a touch on the touch pad section 180 as described above will be described in detail with reference to FIGS. 6 and 7.

FIG. 6 is a flowchart illustrating a method of displaying data on a display section through a touch on the touch pad in a wireless terminal according to a second embodiment of the present invention. It is assumed that the second embodiment of the present invention uses one channel which is a CPU channel. In the second embodiment of the present invention, the recognition of input coordinates and the update of the display section can be performed through the CPU channel. Also, the second embodiment of the present invention will be described based on the assumption that the first display section has a screen size of ‘96×64’, the second display section has a screen size of ‘128×160’, and the whole address region of the display drive section is ‘224×224’. Herein, it is also assumed that the first display-section address region of the display drive section is ‘96×64’ and the second display-section address region of the display drive section is ‘128×160’. In addition, in the second embodiment of the present invention, the control section may include a buffer which stores data to be output to the display section so that the control section may output the data stored in the buffer when outputting the data to the display section.

Hereinafter, the second embodiment of the present invention will be described in detail with reference to FIGS. 2 and 4.

Referring to FIG. 6, when a pen or a user's finger of the wireless terminal touches the touch pad section 180, the touch screen recognition section 165 of the display drive section detects this at step 181 and recognizes a first event to be generated at step 182. After reading input coordinates corresponding to the first event, the touch screen recognition section 165 transfers the input coordinates to the control section 110 through the CPU channel at step 183. While such a process is performed, a pen or a user's finger again touches the touch pad section 180, the touch screen recognition section 165 detects this at step 184 and recognizes a second event to be generated at step 185.

Then, the control section 110 performs step 186 to output data corresponding to the input coordinates for the first event into the display section. At step 186, the control section 110 detects the address of the data. If the address of the data is ‘128×160’, the control section 110 detects this and transfers the data to the display drive section 160 through the CPU channel. Then, the display drive section 160 outputs the data to the second display section 172 through the second display-section address region. When a process for the first event is completed, the touch screen recognition section 165 reads input coordinates corresponding to the second event at step 187 and then transfers the input coordinates to the control section 110 through the CPU channel. Then, the control section 110 performs step 188 to output data corresponding to the input coordinates for the second event to the display section after detecting the address of the data. If the address of the data is ‘128×160’, the control section 110 detects this and transfers the data to the display drive section 160 through the CPU channel. Then, the display drive section 160 outputs the data to the second display section 172 through the second display-section address region.

FIG. 7 is a flowchart illustrating a method of displaying data on a display section through a touch on the touch pad in a wireless terminal according to a third embodiment of the present invention. It is assumed that the third embodiment of the present invention uses two channels are used and the used channels are a Red Green Blue (RGB) channel and a Serial Peripheral Interface (SPI) channel. In the third embodiment of the present invention, the display section is updated through the RGB channel, and a comment is transmitted and input coordinates are recognized through the SPI channel. Also, the third embodiment of the present invention will be described based on the assumption that the first display section has a screen size of ‘96×64’, the second display section has a screen size of ‘128×160’, and the whole address region of the display drive section is ‘224×224’. Herein, it is also assumed that the first display-section address region of the display drive section is ‘96×64’ and the second display-section address region of the display drive section is ‘128×160’. In addition, in the third embodiment of the present invention, the control section may include a buffer which stores data to be output to the display section so that the control section may output the data stored in the buffer when outputting the data to the display section.

Hereinafter, the third embodiment of the present invention will be described in detail with reference to FIGS. 2 and 4.

Referring to FIG. 7, when a pen or a user's finger of the wireless terminal touches the touch pad section 180, the touch screen recognition section 165 of the display drive section detects this at step 191 and recognizes a first event to be generated at step 192. After reading input coordinates corresponding to the first event, the touch screen recognition section 165 transfers the input coordinates to the control section 110 through the SPI channel at step 193. While such a process is performed, a pen or a user's finger again touches the touch pad section 180, the touch screen recognition section 165 detects this at step 194 and recognizes a second event to be generated at step 195. When the second event is generated, a process for the first event is terminated at step 196. Then, the touch screen recognition section 165 reads input coordinates corresponding to the second event at step 197 and transfers the input coordinates to the control section 110 through the SPI channel. Then, the control section 110 performs step 198 to output data corresponding to the input coordinates for the second event to the display section after detecting the address of the data. If the address of the data is ‘128×160’, the control section 110 detects this and transfers the data to the display drive section 160 through the RGB channel. Then, the display drive section 160 outputs the data to the second display section 172 through the second display-section address region.

The present invention can be commonly applied to wireless terminals having a first display section and a second display section. Combination of display sections which can be applied to the present invention includes not only dual display section types including the same type of two display sections, such as Thin Film Transistor (TFT) and TFT, Ultra Fine and Bright (UFB) and UFB, Thin Film Diode (TFD) and TFD, and Organic Light Emitting Diode (OEL) and OEL, but also combinations of different types of display sections. In addition, the embodiments of the present invention can be identically applied to the case of a display section in which a touch screen function is added to the above-mentioned combination of display sections.

Therefore, according embodiments of the present invention, the controlling of at least two display sections and the detecting of the input of the touch pad are performed by one display drive section, so that there are advantages in that the mounting area is minimized, functions are realized with ease, and material costs are reduced.

While the invention has been shown and described with reference to certain embodiments thereof, it should be understood by those skilled in the art that various changes in form and details may be made therein without departing from the spirit and scope of the invention as defined by the appended claims.

1. A device for displaying a screen in a wireless terminal, the device comprising:
a display section for displaying input data, the display section including a first display section and a second display section;
a display drive section having an address region for the first display section and an address region for the second display section; and
a control section for controlling the display drive section to display input data on the first display section and the second display section.

2. The device as claimed in claim 1, further comprising a touch pad section for performing an input operation through a touch, and a touch screen drive section for detecting the touch on the touch pad section.

3. A device for displaying a screen in a wireless terminal, the device comprising:
a display section for displaying input data, the display section including a first display section and a second display section;
a touch pad section for performing an input operation through a touch;
a display drive section having an address region for the first display section and an address region for the second display section, and detecting a touch on the touch pad section; and
a control section for controlling the display drive section to display input data on the first display section and the second display section.

4. A method for displaying a screen in a wireless terminal, the method comprising the steps of:
inputting data;
detecting an address of the input data;
displaying the data on at least one of a first display section and a second display section according to the address of the data.

5. A method for displaying a screen in a wireless terminal, the method comprising the steps of:
determining whether a folder is opened or closed when data are input;
detecting an address of the data when the folder is determined to be opened; and
displaying the data on at least one of a first display section and a second display section according to the address of the data.

6. The method as claimed in claim 5, further comprising the step of displaying the data on a first display section or a second display section when the folder is determined to be closed.

7. A method for displaying a screen in a wireless terminal which includes a touch pad and a display section having a first and a second display section, the method comprising the steps of:
generating a first event through an input from the touch pad;
generating a second event through another input from the touch pad during an execution of the first event;
reading a coordinate value of the first event to display relevant data on the display section; and
reading a coordinate value of the second event to display relevant data on the display section when the execution of the first event is completed.

8. A method for displaying a screen in a wireless terminal which includes a touch pad and a display section having a first and a second display section, the method comprising the steps of:
generating a first event through an input from the touch pad;
generating a second event through another input from the touch pad during an execution of the first event; and
reading a coordinate value of the second event to display relevant data on the display section after ending the execution of the first event.

9. The method as claimed in claim 7, wherein the step of displaying relevant data on the display section comprises the steps of:
inputting data;
detecting an address of the input data; and
displaying the data on at least one of the first display section and the second display section according to the address of the data.

10. The method as claimed in claim 8, wherein the step of displaying relevant data on the display section comprises the steps of:
inputting data;
detecting an address of the input data; and
displaying the data on at least one of the first display section and the second display section according to the address of the data.

11. The method as claimed in claim 7, wherein, the step of displaying relevant data on the display section comprises the steps of:
determining whether a folder is opened or closed when the data are input;
detecting an address of the data when the folder is determined to be opened; and
displaying the data on at least one of the first display section and the second display section according to the address of the data.

12. The method as claimed in claim 8, wherein, the step of displaying relevant data on the display section comprises the steps of:
determining whether a folder is opened or closed when the data are input;
detecting an address of the data when the folder is determined to be opened; and
displaying the data on at least one of the first display section and the second display section according to the address of the data.

13. The method as claimed in claim 7, wherein, the step of displaying relevant data on the display section comprises the steps of:
determining whether a folder is opened or closed when the data are input; and
displaying the data on the first display section or the second display section when the folder is determined to be closed.

14. The method as claimed in claim 8, wherein, the step of displaying relevant data on the display section comprises the steps of:
determining whether a folder is opened or closed when the data are input; and
displaying the data on the first display section or the second display section when the folder is determined to be closed.
